(19) United States
(12) Patent Application Publication
(10) Pub. No.: US 2025/0211915 A1
(43) Pub. Date: Jun. 26, 2025

(54) INTERIOR STRUCTURE OF VEHICLE

(71) Applicant: HONDA MOTOR CO., LTD., Tokyo (JP)

(72) Inventors: Yusuke Ienaka, Tokyo (JP); Kosuke Ito, Tokyo (JP); Hirofumi Uchiyama, Tokyo (JP); Tomoyuki Maruo, Tokyo (JP)

(21) Appl. No.: 18/989,012

(22) Filed: Dec. 20, 2024

(30) Foreign Application Priority Data
Dec. 26, 2023 (JP) 2023-219863

(51) Int. Cl. H04R 9/06; B60Q 3/51; B60Q 3/76; B60R 11/00; B60R 11/02; B60R 11/04; H04R 1/02

(52) U.S. Cl. CPC H04R 9/06; B60Q 3/51; B60Q 3/76; B60R 11/0217; H04R 1/025; B60R 2011/0028; B60R 11/04; H04R 2499/13

(57) ABSTRACT

An interior structure of a vehicle includes a roof console and an exciter. The roof console is disposed on a ceiling portion inside a vehicle cabin. The exciter generates vibrations according to an acoustic signal. The roof console includes a console main body in which input and output devices are mounted, and a console panel made of a hard resin to cover a side of the console main body that faces an inside of the vehicle cabin. The exciter is mounted on the console panel.

### CROSS-REFERENCE TO RELATED APPLICATION

Priority is claimed on Japanese Patent Application No. 2023-219863, filed Dec. 26, 2023, the content of which is incorporated herein by reference.

### BACKGROUND OF THE INVENTION

### Field of the Invention

The present invention relates to an interior structure of a vehicle equipped with an acoustic exciter in a ceiling portion.

### Description of Related Art

In recent years, vehicles in which sound sources such as speakers are installed at a plurality of locations within a vehicle cabin in order to improve an acoustic environment within an interior of a vehicle have been proposed. However, the locations at which sound sources can be installed within the interior of the vehicle are limited to the inside of side doors, pillars, and the like, and securing locations for installing sound sources that can create a good acoustic space is a challenge.

As a countermeasure to this problem, a method in which an exciter (a sound exciter) is installed in a ceiling portion within an interior of a vehicle, and vibrations generated by the exciter vibrate a dedicated support plate installed in the ceiling portion or an interior material itself has been devised (refer to, for example, Patent Documents 1 and 2 below).

In an interior structure of a vehicle described in Patent Document 1, a support plate is installed on the back side (the upper side) of an interior material of a ceiling portion, and an exciter is mounted on the support plate. In this interior structure, the exciter vibrates the support plate with generated vibrations, and acoustic vibration resonates throughout the interior in the ceiling portion. Therefore, this interior structure does not require a dedicated diaphragm (cone), and a sound source does not significantly overwhelm an interior space.

In an interior structure of a vehicle described in Patent Document 2, an exciter is mounted via a coupler on a lower surface of an interior material in a ceiling portion, which is made of urethane, a foamed resin or the like. In this interior structure, the exciter vibrates the interior material itself with generated vibrations and thus causes acoustic vibrations to resonate throughout the interior in the ceiling portion. In this case too, since there is no need for a dedicated diaphragm (cone), a sound source does not significantly overwhelm an interior space.

[Patent Document 1] Japanese Unexamined Patent Application, First Publication No. 2012-160781

[Patent Document 2] Japanese Unexamined Patent Application, First Publication No. 2006-180368

### SUMMARY OF THE INVENTION

Incidentally, in the interior structure of a vehicle described in Patent Document 1, since the support plate which is vibrated by the vibrations generated by the exciter is installed on the back side (the upper side) of the interior material in the ceiling portion, the interior material impedes transmission of acoustic vibrations from the support plate to the interior space, and thus the acoustic vibrations of the support plate cannot resonate efficiently throughout the interior of the vehicle.

In the interior structure of a vehicle described in Patent Document 2, since a target to be vibrated by the vibrations generated by the exciter is the interior material in the ceiling portion, which is made of urethane, a foam resin, or the like, a vibrating part faces directly the interior of the vehicle, but it is difficult to obtain good quality acoustic vibrations due to material properties of the interior material.

The aspect of the present invention has been made in consideration of the above circumstances, and an object thereof is to provide an interior structure of a vehicle that can curb a sound source significantly overwhelming an interior space and can cause high- quality acoustic vibrations to resonate at a ceiling portion.

In order to solve the above problems and achieve the above object, the present invention employs the following aspects.

(1) An interior structure of a vehicle according to the present invention includes a roof console disposed on a ceiling portion inside a vehicle cabin, and an exciter configured to generate vibrations according to an acoustic signal, wherein the roof console includes a console main body in which input and output devices are mounted, and a console panel made of a hard resin to cover a side of the console main body that faces an inside of the vehicle cabin, and the exciter is mounted on the console panel.

With such a configuration, the exciter is mounted on the console panel in the ceiling portion that faces directly the inside of the vehicle cabin. The vibrations generated by the exciter vibrate the console panel made of a hard resin, and the vibrations are transmitted to an interior space of the vehicle cabin. Thus, a sound source does not significantly overwhelm the interior space, and it is possible to cause high-quality acoustic vibrations to resonate in the ceiling portion.

(2) In the aspect (1), the exciter may be mounted on an upper surface of a substantially flat plate portion of the console panel.

In this case, since the exciter is mounted on the upper surface side of the console panel, the exciter does not protrude further to the inside of the vehicle than the console panel. Since the exciter is mounted on the substantially flat plate portion of the console panel, the substantially flat plate portion can be vibrated satisfactorily by the vibrations generated by the exciter. Therefore, when this configuration is adopted, it is possible to obtain better quality acoustic vibrations.

(3) In the aspect (2), the exciter may be mounted in a free end region of the console panel that is not fixed to either a roof panel of a vehicle body or the console main body.

In this case, since the exciter is mounted in the free end region of the console panel, the acoustic vibration portion of the console panel is less likely to be strongly constrained by the surroundings, and thus it is possible to obtain better acoustic vibrations.

(4) In the aspect (3), an outer edge portion of the free end region may be formed to have a substantially arc shape when seen from above, and the exciter may be disposed at a position spaced apart from the outer edge portion having the substantially arc shape.

In this case, the vibrations generated by the exciter can be efficiently transmitted to the vicinity of the central portion of the free end region of the console panel. Therefore, when this configuration is adopted, it is possible to obtain better acoustic vibrations.

(5) In the aspect (1), the exciter may include a voice coil that converts a signal current into vibration, and a middle portion of a wire connected to the voice coil may be fixed to the roof panel of the vehicle body.

In this case, unlike a case in which the middle portion of the wire connected to the voice coil is fixed to the console panel, the middle portion of the wire does not come into contact with the console panel, and thus the good acoustic vibrations of the console panel are no longer hindered by the wire.

(6) In the aspect (1), the exciter may be disposed at a substantially central position in a vehicle width direction above front seats inside the vehicle cabin.

In this case, the vibrations generated by the exciter can resonate evenly in both left and right directions inside the vehicle cabin. Therefore, when this configuration is adopted, it is possible to obtain better acoustic vibrations.

(7) In the aspect (2), the roof console may have an emergency switch that is pushed upward in an emergency, and the emergency switch may be disposed at a position recessed upward from the substantially flat plate portion of the console panel on which the exciter is mounted.

In this case, an arrangement portion of the emergency switch which is likely to be touched by a finger of an occupant to confirm a location thereof is recessed upward from the substantially flat plate portion of the console panel. Therefore, even if a surrounding portion of the emergency switch is touched by the finger of the occupant when the substantially flat plate portion of the console panel is acoustically vibrating as a diaphragm, the good acoustic vibrations of the substantially flat plate portion of the console panel are less likely to be hindered by contact with the finger.

(8) In the aspect (1), the roof console may further include a camera configured to capture an image of the inside of the vehicle cabin, and a map lamp configured to illuminate a region near the front seat inside the vehicle cabin, and the camera, the map lamp, and the exciter may be disposed on the roof console in this order from a front of the vehicle.

In this case, since the camera is disposed on the front end side of the roof console, a wider range of the interior of the vehicle can be imaged. The map lamp can now be disposed almost above the front seats, and the exciter can be disposed inside the interior of the vehicle close to both the front and rear seats. Thus, the map lamp is disposed for easy access by front seat occupants, and the exciter can resonate good acoustic vibrations toward both the front and rear seats.

According to an aspect of the present invention, since an exciter is mounted on a console panel in a ceiling portion that directly faces the inside of the vehicle cabin, the vibrations generated by the exciter can effectively vibrate the console panel formed of a hard resin, and the vibrations can resonate throughout an interior space. Therefore, according to this aspect of the present invention, it is possible to curb a sound source from significantly overwhelming the interior space and to cause high-quality acoustic vibrations to resonate in the ceiling portion.

### BRIEF DESCRIPTION OF THE DRAWINGS

FIG. 1 is a plan view of a vehicle according to an embodiment.

FIG. 2 is a perspective view showing an interior of a vehicle according to the embodiment.

FIG. 3 is a cross-sectional view taken along line III-III in FIG. 2.

FIG. 4 is a top view of a roof console according to the embodiment.

FIG. 5 is a perspective view of a portion of the roof console according to the embodiment, which corresponds to an arrow V in FIG. 4.

### DETAILED DESCRIPTION OF THE INVENTION

Hereinafter, an embodiment of the present invention will be described with reference to the drawings. The drawings show an arrow FR indicating forward of a vehicle, an arrow UP indicating upward of the vehicle, and an arrow LH indicating the left side of the vehicle.

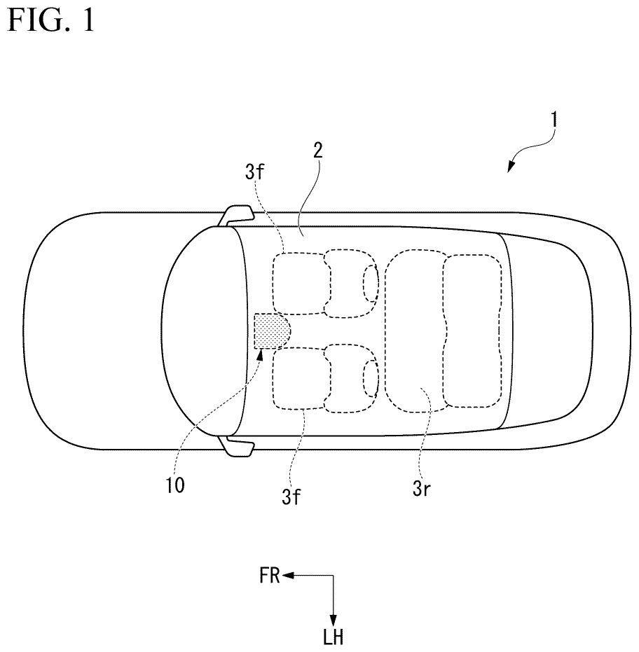

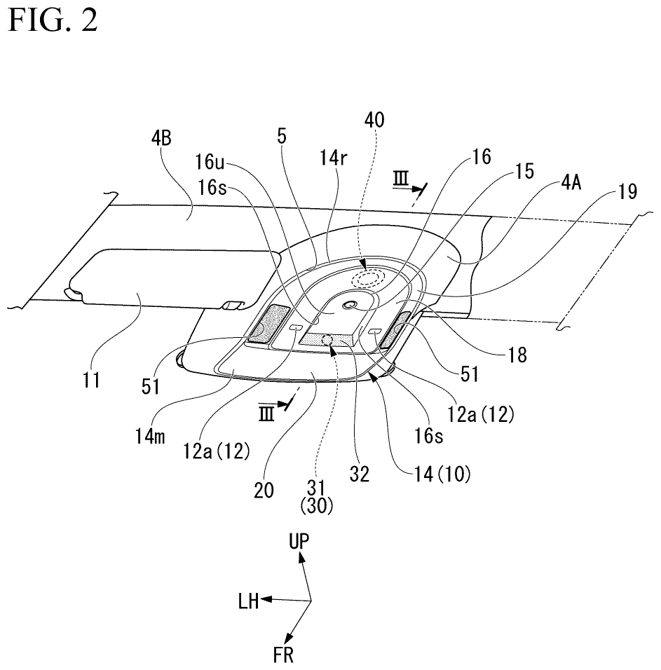

FIG. 1 is a plan view of a vehicle 1 according to an embodiment, and FIG. 2 is a perspective view of a ceiling portion in an interior of the vehicle 1 when seen from the rear lower side.

In FIG. 1, a reference numeral 2 is a roof panel of the vehicle 1, and reference numerals 3f and 3r are front and rear seats installed in the interior of the vehicle 1. In FIG. 2, a reference numeral 10 is a roof console disposed in a central region of the ceiling portion above the front seats within a vehicle cabin in a vehicle width direction, and a reference numeral 11 is a sun visor disposed above the front seats in the ceiling portion of the interior of the vehicle.

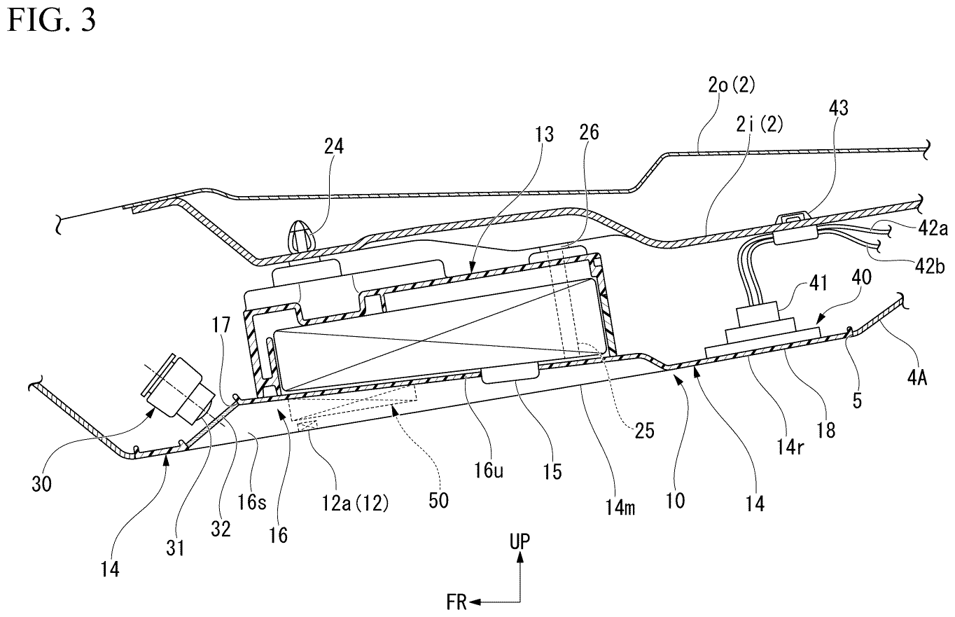

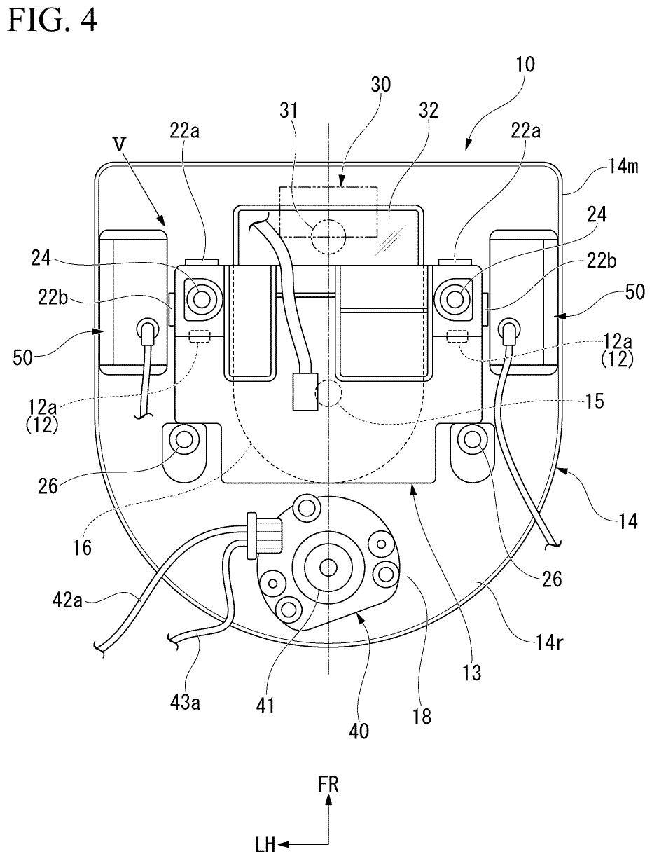

FIG. 3 is a cross-sectional view taken along line III-III in FIG. 2, and FIG. 4 is a top view of the roof console 10.

As shown in FIGS. 3 and 4, the roof console 10 includes a console main body 13 and a plate-shaped console panel 14 that covers the console main body 13 on the inside of the vehicle cabin. The console main body 13 is a resin or metal housing in which operating devices (switch mechanisms, operating circuits, and the like) for input and output devices such as map lamps 12 and emergency switches 15 (refer to FIGS. 2 and 3) are mounted. The console panel 14 is made of a hard resin having a high density.

As shown in FIG. 4, the console panel 14 has a shape in which a substantially semicircular shape is combined with one side of a substantially square shape when seen from above. In the console panel 14, a substantially square-shaped portion is disposed on the front side of the vehicle, and a substantially semicircular portion is disposed on the rear side of the vehicle. In the following, for ease of explanation, the square-shaped portion when seen from above is referred to as a “main region 14m,” and the substantially semicircular portion when seen from above is referred to as a “rear extension region 14r.”

The console main body 13 and the console panel 14 are fixed to the roof panel 2 by clips, bolts or the like in the central region of the ceiling portion of the interior of the vehicle in the vehicle width direction. The roof panel 2 is configured of an outer roof panel 2o and an inner roof panel 2i which are joined together to form a closed cross-sectional structure. The console main body 13 and the console panel 14 are fixed to the inner roof panel 2i.

As shown in FIG. 2, roof linings 4A and 4B (interior materials) made of urethane, a foamed resin or the like are disposed around the console panel 14 in the ceiling portion. A lower surface of the console panel 14 is exposed to the interior side of the vehicle through an opening portion 5 in the roof lining 4A.

A recessed portion 16 of which a central region is recessed upward from a peripheral edge portion is formed in the main region 14m of the console panel 14. A shape of the recessed portion 16 when seen from below is substantially similar to an exterior of the console panel 14 but scaled down. In other words, the shape of the recessed portion 16 when seen from below is such that a substantially semicircular portion is combined with a rear side of a substantially square portion. An inclined surface that is inclined upward from the front side to the rear side of the vehicle is provided on a front side of the substantially square portion of the recessed portion 16. An opening 17 (refer to FIG. 3) is formed in this inclined surface portion, and a cover glass 32 (a transparent resin panel) is mounted in the opening 17 to cover the front (the rear side of the vehicle) of an imaging unit 31 (a lens) of a camera 30 which will be described below.

An operating portion of the emergency switch 15 described above is disposed on an upper wall 16u (a wall forming a bottom of the recessed portion) of the recessed portion 16. The operating portion of the emergency switch 15 is disposed so as to penetrate the upper wall 16u of the recessed portion 16, and is capable of operating a switch main body portion (not shown) on the console main body 13 side. The emergency switch 15 turns on the switch main body portion by pushing the operating portion upward. When the switch main body portion is turned on, the emergency switch 15 is connected to, for example, an emergency support center via communication.

As shown in FIG. 2, a peripheral portion of the recessed portion 16 of the console panel 14 is a first base wall 18 that surrounds the recessed portion 16 in a substantially U-shape. A lower surface of the first base wall 18 is formed to be substantially flat. A second base wall 19 having a lower surface of which a height is slightly higher than that in the first base wall 18 is disposed on a peripheral portion of the first base wall 18. The second base wall 19 is formed to surround the outside of the first base wall 18 in a substantially U-shape. A front base wall 20 of which a lower surface is at approximately the same height as a lower surface of the first base wall 18 is disposed on the vehicle front side of the first base wall 18 and the second base wall 19.

As shown in FIG. 2, light emitting portions 12a of the map lamps 12 for a driver's seat and a passenger's seat are respectively disposed on front-rear extending portions on one side and the other side of the substantially U-shaped first base wall 18 in the vehicle width direction. Each of the light emitting portions 12a is capable of radiating light downward on the driver's seat side and downward on the passenger's seat side, respectively. In this embodiment, lower surfaces of the left and right front-rear extending portions of the first base wall 18 are used as arrangement surfaces of the light emitting portions 12a of the map lamps 12. The recessed portion 16 of the console panel 14 is formed to be recessed upward with respect to the arrangement surface of the light emitting portion 12a.

As shown in FIGS. 3 and 4, the camera 30 for capturing images of the interior of the vehicle is disposed at a front end position (a position in front of the vehicle) within the recessed portion 16 of the console panel 14. The camera 30 is fixed to the roof panel 2, the console main body 13, or the like via a bracket (not shown).

Here, the imaging unit 31 of the camera 30 is disposed such that an imaging direction faces downward toward the rear within the vehicle cabin through the opening 17 at the front of the recessed portion 16 of the console panel 14. The camera 30 is disposed such that at least a central position (a central position of a front surface of the lens) of the imaging unit 31 on the front surface side is located above the lower surface of the above-described first base wall 18 of the console panel 14. A central position (a central position of a front surface of the lens) of the imaging unit 31 of the camera 30 on the front surface side is disposed above the light emitting portion 12a of the map lamp 12 disposed on the first base wall 18. A lower end of the imaging unit 31 of the camera 30 is located above a lower end of the light emitting portion 12a of the map lamp 12.

As shown in FIGS. 3 and 4, an exciter 40 (a sound exciter) is installed on the upper surface side of a rear curved portion of the substantially U-shaped first base wall 18. The exciter 40 is mounted on an upper surface of the approximately semicircular rear extension region 14r of the console panel 14. The exciter 40 includes a voice coil 41 that receives a signal current input from the outside and generates vibrations, and a magnetic circuit (not shown). The vibrations generated by the exciter 40 cause a substantially flat plate portion of the console panel 14 (mainly, the rear extension region 14r) to vibrate as a diaphragm. Thus, the vibrations generated in the substantially flat plate portion of the console panel 14 are transmitted as acoustic vibrations into a space within the vehicle cabin.

As shown in FIG. 3, middle portions of wires 42a and 42b such as signal wires drawn from the voice coil 41 of the exciter 40 are fixed to the lower surface of the roof panel 2 (the inner roof panel 2i) via fixing clips 43 or the like.

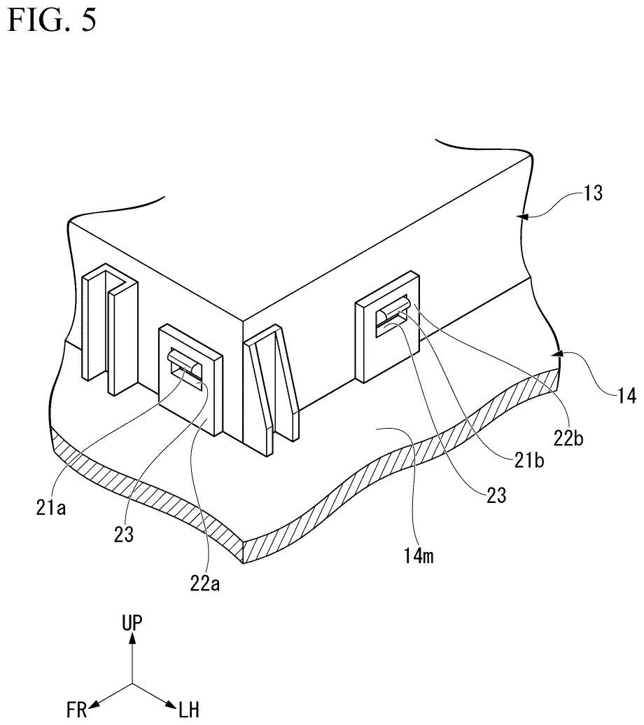

FIG. 5 is a perspective view of a portion of the roof console 10 corresponding to the arrow V in FIG. 4.

As shown in FIG. 5, locking pawls 21a and 21b are provided to protrude from a front surface and a front side surface of the housing of the console main body 13, respectively. The main region 14m of the console panel 14 has engagement pieces 22a and 22b that protrude therefrom at positions corresponding to the engagement claws 21a and 21b on the console main body 13 side. Each of the engagement pieces 22a and 22b protrudes upward from an upper surface of the console panel 14, and an engagement hole 23 is formed in a protruding portion thereof so as to penetrate in a plate thickness direction. The locking pawls 21a and 21b on the console main body 13 side are engaged with the engagement holes 23 of the corresponding engagement pieces 22a and 22b on the console panel 14 side. A front portion of the main region 14m of the console panel 14 is fixed to the console main body 13 by engaging the locking pawls 21a and 21b with the corresponding engagement holes 23.

As shown in FIGS. 3 and 4, fixing clip portions 24 made of a resin are provided on left and right front upper surface of the console main body 13 to protrude therefrom. The fixing clip portions 24 are fitted into fixing holes (not shown) formed in the roof panel 2 (the inner roof panel 2i). Thus, the front side of the console main body 13 is fixed to the roof panel 2 (the inner roof panel 2i).

A pair of support protrusions 25 that protrude upward from the upper surface of the console panel 14 are provided at positions spaced apart on the left and right sides of a rear portion of the main region 14m of the console panel 14. A fixing clip portion 26 made of a resin is provided on an upper portion of each of the support protrusions 25 to protrude therefrom. This fixing clip portion 26 is fitted into a fixing hole (not shown) formed in the roof panel 2 (the inner roof panel 2i). Thus, the left and right sides of the rear portion of the main region 14m of the console panel 14 are fixed to the roof panel 2 (the inner roof panel 2i).

Here, as described above, although the front and rear of the main region 14m of the console panel 14 are fixed to the console main body 13 and the roof panel 2 (the inner roof panel 2i), respectively, the rear extension region 14r, which is substantially semicircular when seen from above, is not fixed to the console main body 13 or the roof panel 2. In other words, the rear extension region 14r which has a substantially flat plate shape and in which the exciter 40 is mounted is a free end that is not constrained by the console main body 13 or the roof panel 2.

Time-of-Flight (TOF) cameras 50 for acquiring distance information to a subject are disposed on both left and right sides of the console main body 13 fixed to the upper surface of the main region 14m of the console panel 14. The TOF camera 50 can recognize a shape and behavior of a subject by irradiating the subject with infrared light and calculating a time it takes for the infrared light to return. The TOF cameras 50 disposed on both the left and right sides of the console main body 13 are mounted so as to be able to identify faces, behaviors, and the like of an occupant seated in a driver's seat and an occupant seated in a passenger's seat.

A reference numeral 51 in FIG. 2 is an entrance and exit window of the infrared light provided on the console panel 14 at a position outside the light emitting portion 12a of each of the left and right map lamps 12 in the vehicle width direction. A cover that allows infrared light to pass through is mounted in the entrance and exit window 51.

As described above, in the interior structure of a vehicle of this embodiment, the exciter 40 is mounted on the console panel 14 which is made of a hard resin in the ceiling portion and directly faces the inside of the vehicle cabin. Therefore, the console panel 14 made of a hard resin is vibrated by the vibrations generated by the exciter 40, and the vibrations can resonate well in the interior space.

Therefore, when the interior structure of a vehicle of this embodiment is adopted, it is possible to curb the sound source significantly overwhelming the interior space and to cause high-quality acoustic vibrations to resonate in the ceiling portion.

In this embodiment, the exciter 40 is mounted on the upper surface of the rear extension region 14r which is a substantially flat plate portion of the console panel 14. As a result, the exciter 40 mounted on the console panel 14 does not protrude further to the inside of the vehicle than the console panel 14, and the vibrations generated by the exciter 40 can effectively vibrate the substantially flat plate portion of the console panel 14. Therefore, when this configuration is adopted, it is possible to obtain better quality acoustic vibrations.

In this embodiment, the exciter 40 is mounted in the rear extension region 14r (the free end region) of the console panel 14 which is a free end that is not fixed to either the roof panel 2 or the console main body 13. Therefore, a main acoustic vibration portion (the rear extension region 14r) of the console panel 14 is less likely to be strongly constrained from the surroundings. Therefore, when this configuration is adopted, better acoustic vibrations can be obtained.

Furthermore, in this embodiment, an outer edge portion of the rear extension region 14r of the console panel 14 is formed to have a substantially arc shape, and the exciter 40 is mounted at a position spaced apart from the substantially arc-shaped outer edge portion of the rear extension region 14r. Therefore, the vibrations generated by the exciter 40 can efficiently vibrate a vicinity of a central portion of the rear extension region 14r. Therefore, when this configuration is adopted, it is possible to obtain better acoustic vibrations.

In the interior structure of a vehicle of this embodiment, the exciter 40 includes a voice coil 41 that converts a signal current into vibrations, and the middle portions of the wiring 42a and 42b connected to the voice coil 41 are fixed to the roof panel 2 of the vehicle body. In this case, unlike a case in which the middle portions of the wires 42a and 42b connected to the voice coil 41 are fixed to the console panel 14, good acoustic vibrations of the console panel 14 are not hindered by the wires 42a and 42b. Therefore, when this configuration is adopted, it is possible to obtain better acoustic vibration.

In this embodiment, the exciter 40 is disposed above the front seats in the vehicle cabin at approximately the central position in the vehicle width direction. Thus, it is possible for the vibrations generated by the exciter 40 to resonate evenly in left and right directions within the vehicle cabin. Therefore, when this configuration is adopted, a better acoustic environment can be created inside the vehicle cabin.

Furthermore, in the interior structure of a vehicle of this embodiment, the emergency switch 15 is disposed in the recessed portion 16 of the console panel 14 that is recessed upward with respect to the rear extension region 14r in which the exciter 40 is mounted. Therefore, even if a surrounding portion of the emergency switch 15 is touched by a finger of an occupant when the rear extension area 14r (the substantially flat plate portion) of the console panel 14 is vibrating as a diaphragm, the good acoustic vibrations of the rear extension region 14r (the substantially flat plate portion) of the console panel 14 are less likely to be hindered by contact with the finger. Therefore, when this configuration is adopted, a good acoustic environment can always be obtained.

In the vehicle interior structure of this embodiment, the camera 30, the map lamp 12, and the exciter 40 are disposed on the roof console 10 in this order from the front of the vehicle. Therefore, the camera 30 located at the very front of the roof console 10 can capture images of a wider range of the interior of the vehicle, and the map lamps 12 located behind the camera 30 can effectively illuminate light toward the front seats. Furthermore, since the exciter 40 is disposed at a position close to both the front and rear seats in the interior of the vehicle, it is possible to cause acoustic vibrations to satisfactorily resonate on both the front and rear seat sides.

The present invention is not limited to the above-described embodiment, and various design modifications are possible without departing from the spirit and scope of the present invention. For example, in the above embodiment, in addition to the exciter 40, the camera 30, the map lamps 12, and the TOF camera 50 are provided on the roof console 10, but these are not necessarily required, and some of them may be omitted.

What is claimed is:

1. An interior structure of a vehicle, comprising:
a roof console disposed on a ceiling portion inside a vehicle cabin; and
an exciter configured to generate vibrations according to an acoustic signal,
wherein the roof console includes a console main body in which input and output devices are mounted, and a console panel made of a hard resin to cover a side of the console main body that faces an inside of the vehicle cabin, and
the exciter is mounted on the console panel.

2. The interior structure of a vehicle according to claim 1, wherein the exciter is mounted on an upper surface of a substantially flat plate portion of the console panel.

3. The interior structure of a vehicle according to claim 2, wherein the exciter is mounted in a free end region of the console panel that is not fixed to either a roof panel of a vehicle body or the console main body.

4. The interior structure of a vehicle according to claim 3, wherein an outer edge portion of the free end region is formed to have a substantially arc shape when seen from above, and
the exciter is disposed at a position spaced apart from the outer edge portion having the substantially arc shape.

5. The interior structure of a vehicle according to claim 1, wherein the exciter includes a voice coil that converts a signal current into vibration, and
a middle portion of a wire connected to the voice coil is fixed to the roof panel of the vehicle body.

6. The interior structure of a vehicle according to claim 1, wherein the exciter is disposed at a substantially central position in a vehicle width direction above front seats inside the vehicle cabin.

7. The interior structure of a vehicle according to claim 2, wherein the roof console has an emergency switch that is pushed upward in an emergency, and
the emergency switch is disposed at a position recessed upward from the substantially flat plate portion of the console panel on which the exciter is mounted.

8. The interior structure of a vehicle according to claim 1, wherein the roof console further includes a camera configured to capture an image of the inside of the vehicle cabin, and a map lamp configured to illuminate a region near the front seat inside the vehicle cabin, and
the camera, the map lamp, and the exciter are disposed on the roof console in this order from a front of the vehicle.
